(19) United States
(12) Patent Application Publication
(10) Pub. No.: US 2012/0061317 A1
(43) Pub. Date: Mar. 15, 2012

(54) Magnetic Pollen Grains as Sorbents for Organic Pollutants in Aqueous Media

(76) Inventors: Beng Joo Reginald Thio, Brookline, MA (US); Kristin Clark, Belcamp, MD (US); Arturo Alejandro Keller, Santa Barbara, CA (US)

(21) Appl. No.: 13/227,063

(22) Filed: Sep. 7, 2011

Related U.S. Application Data
(60) Provisional application No. 61/382,419, filed on Sep. 13, 2010.

(51) Int. Cl. B01D 15/08; H01F 1/032

(52) U.S. Cl. 210/631; 252/62.51 R

(57) ABSTRACT

A method of removing a contaminant from liquid is provided. The method includes adding magnetic biological particles to a liquid containing a contaminant, sorbing the contaminant to the magnetic biological particles, and separating the sorbed contaminant from the liquid by applying a magnetic field to the magnetic biological particles. In some versions, the magnetic biological particles are pollen grains having added magnetic material. Also provided are methods of making magnetic biological particles, and compositions containing magnetic biological particles.

### CROSS-REFERENCE TO RELATED APPLICATIONS

This application claims the benefit of Provisional Patent Application No. 61/382,419, filed on Sep. 13, 2010, which is incorporated by reference herein.

### STATEMENT REGARDING FEDERALLY SPONSORED RESEARCH OR DEVELOPMENT

This invention was made with Government support under Grant No. NSF-EF0830117 from the National Science Foundation. The Government has certain rights in this invention.

### BACKGROUND

1. Field of the Invention

The invention relates to removal of chemical compounds from liquids.

2. Related Art

Hydrophobic organic compounds (HOCs) including many pesticides, some pharmaceuticals, polychlorinated biphenyls (PCBs) and polycyclic aromatic hydrocarbons (PAHs) are ubiquitous environmental contaminants and their presence in drinking water, wastewater, soils and sediments poses a serious risk to human and local ecosystem health. One of the most commonly used sorbents for HOCs removal in contaminated water is activated carbon. However, the high temperatures (up to 800° C.) and energy costs required for thermal regeneration of activated carbon (14) makes it appealing to look for a low-cost alternative of similar or better efficiency. Many novel polymeric sorbents have been developed (15-18), but the cost of their synthesis has generally made them not viable.

Pollen grains are the physiological containers that produce the male gametes of seed plants, and have long been closely studied by plant physiologists (1-8), chemists (9), chemical engineers (10) and material scientists (11) for diverse reasons and applications. The outer layer (exine) of the grain is made of an extremely stable and complex biopolymer known as sporopollenin which is highly resistant to chemical attack, and has been functionalized for uses in ion exchange (12) and drug delivery (9).

### SUMMARY

Plant cuticular materials have been shown to sorb organic compounds. However, very little is known about the ability of pollen grains to act as sorbents to remove hydrophobic organic compounds (HOCs) such as pesticides, polycyclic aromatic hydrocarbons (PAHs) and polychlorinated biphenyls (PCBs) from contaminated aqueous media. In some aspects, the inventors have discovered a facile and effective method to remove HOCs from water using magnetized short ragweed (A. artemisiifolia) pollen grains. Magnetic pollen grains are readily separated from the aqueous media via a magnetic field after adsorption of the HOCs. The adsorption of six representative HOCs (acenaphthene, naphthalene, phenanthrene, atrazine, diuron, and lindane) onto magnetized ragweed pollen is characterized. Also, the adsorption capacity of the ragweed pollen can be regenerated to a large extent for reuse as a sorbent. Magnetized pollen grains can be as efficient as activated carbon in the removal of HOCs from contaminated waters. The pollen grains have the additional advantages of being economical, widely available worldwide and easy to separate from water with an external magnetic field once magnetized. The low energy requirements and cost of the synthesis of the magnetized ragweed pollen make it an excellent candidate for decontaminating drinking water supplies worldwide

In one aspect, a method of removing a contaminant from liquid is provided. The method includes adding magnetic biological particles to a liquid containing a contaminant, sorbing the contaminant to the magnetic biological particles, and separating the sorbed contaminant from the liquid by applying a magnetic field to the magnetic biological particles. The liquid can be water or an aqueous liquid. The contaminant can be a volatile organic compound, a semi-volatile organic compound, a phenolic compound a polycyclic aromatic hydrocarbon, a polychlorinated biphenyl, or an organic pesticide, insecticide or herbicide, or any combination thereof. In some embodiments, the contaminant is a hydrophobic organic compound (HOC). In any embodiment, each of the magnetic biological particles can include a biological particle and a magnetic material, which can be a magnetic material added to the biological particle. In any of these embodiments, the biological particle can be a pollen grain, chitin, chitosan, a plant cuticle, a biofilm, or a fungal spore, and the magnetic biological particles as a whole can comprise pollen grains, chitin molecules, chitosans, plant cuticles, biofilms, or fungal spores, or a combination thereof. The magnetic material in any embodiment can be a ferromagnetic or superparamagnetic material, or a combination thereof. The method can further include collecting the magnetic biological particles after applying the magnetic field, and reusing the collected magnetic biological particles by adding them to contaminated liquid and repeating the sorbing and separating steps. For reuse, the contaminant can be removed from the magnetic biological particles before reusing, or the magnetic biological particles can be reused without removing the previously sorbed contaminant.

In another aspect, a method of preparing a magnetic biological particle is provided. The method includes adding a magnetic material to a biological particle in an amount to produce a composite particle that is attracted by a magnetic field. In any embodiment, the biological particle can be capable of sorbing a contaminant, which can be a hydrophobic organic compound (HOC). In the method, the biological particle can be a pollen grain, chitin, chitosan, a plant cuticle, a biofilm, or a fungal spore. The magnetic material in any embodiment can be a ferromagnetic or superparamagnetic material, or a combination thereof.

In a further aspect, a magnetic composition is provided. The composition includes biological particles having added magnetic material in an amount such that the biological particles are attracted by a magnetic field. In any embodiment, the biological particles can be capable of sorbing a contaminant, which can be a hydrophobic organic compound (HOC). In the composition, the biological particles can be pollen grains, chitin molecules, chitosans, plant cuticles, biofilms, or fungal spores, or a combination thereof. The magnetic material in any embodiment can be a ferromagnetic or superparamagnetic material, or a combination thereof.

### BRIEF DESCRIPTION OF THE DRAWINGS

For a more complete understanding of the present invention, reference is now made to the following descriptions taken in conjunction with the accompanying drawing.

FIG. 1 is a schematic drawing of sorption of a chemical compound to a magnetic pollen grain.

FIG. 2 is a panel of SEM images of untreated and magnetized ragweed pollen grains.

FIG. 3 is a panel showing recovery testing of magnetized ragweed pollen from contaminated media by an external magnetic field.

FIG. 4 is a panel of sorption isotherms for pesticides using magnetized ragweed pollen and activated carbon.

FIG. 5 is a graph of percent change of sorption of diuron onto magnetized ragweed pollen for five regeneration cycles.

FIG. 6 is a panel of sorption isotherms for pesticides using ragweed pollen (without iron coating).

### DETAILED DESCRIPTION

Short ragweed (A. artemisiifolia) is a weed native to North America but is now found worldwide and its wind-dispersed pollen is readily and easily available in large quantities (13). It is likely that other pollen may also be suitable sorbents, such as but not limited to cottonwood, western Populus deltoides ssp. Monilifera, sagebrush, common Artemisia tridentate, goldenrod Solidago spp., and burrobrush Hymenoclea salsola, or a combination of pollen grains; short ragweed pollen was selected initially due to its low cost and wide availability. The potential for pollen grains to be used as sorbents has not been evaluated before.

Magnetic sorbents have demonstrated potential as a material for environmental remediation (19). Magnetic separation of the sorbent from the treated aqueous media by an external magnetic field is much easier, faster and cheaper than the traditional methods of filtration, centrifugation or gravitational separation. High reusability of the sorbent is also a desirable property.

In general terms, a contaminant is a chemical substance harmful or potentially harmful to the ecology. Examples of contaminants include, but are not limited to, volatile organic compounds, semi-volatile organic compounds, acid extractable compounds, phenolic compounds, base neutral compounds, polycyclic aromatic hydrocarbons, polychlorinated biphenyls, pesticides, insecticides, herbicides, metals, and radionuclides. Examples of hydrophobic organic compounds (HOCs) include, but are not limited to: volatile organic compounds; semi-volatile organic compounds; phenolic compounds; polycyclic aromatic hydrocarbons; polychlorinated biphenyls; organic pesticides, insecticides and herbicides; explosives; toxic industrial contaminants; disinfection byproducts; disinfectants; DDT; 2,4-dinitrotoluene; RDX; allylamine; chloroacetone; chloroacetonitrile; chlordane; benzo(a)pyrene; dioxin; and toluene.

A magnetic biological particle or composition comprises a biological particle and a magnetic material. The biological particle is a particle found in, or obtained from, a biological source such as an animal, plant, bacteria, or cell, or a preparation thereof. Examples of biological particles include, but are not limited to, pollen grains, chitin, chitosan, plant cuticles, biofilms, and fungal spores, and a combination thereof. In certain embodiments, a biological particle has size dimensions of 1 nm-50 μm. In accordance with embodiments of the invention, a biological particle is capable of sorbing a contaminant, which in certain embodiments is an HOC. Because a particular biological particle may sorb a specific contaminant better than another biological particle, the particular particle used in an embodiment can depend upon the specific contaminant to be removed.

Magnetic materials that can be used to prepare magnetic biological particles include, but are not limited to, ferromagnetic materials and superparamagnetic materials, particularly iron oxides (such as magnetite, maghemite), metals (such as Ni, Co, Fe), alloys (such as FePt, CoPt, FePd, CoPd, and other magnetic oxides and nitrides), compounds such as CoSeO₄, VOSe₂O₅, and Mn(C₄H₄O₄), and a combination thereof.

In some embodiments, a particular magnetic biological particle may be found in nature. In other embodiments, a magnetic biological particle is obtained by adding a magnetic material to a non-magnetic biological particle or to a biological particle that cannot be separated from a liquid by a magnetic field until additional magnetic material is added. The derived magnetic biological particle or composite can then be used to clean a contaminated liquid.

In use, magnetic biological particles can be added to a contaminated liquid. After allowing time for sorbing of the contaminant to the magnetic biological particles, a magnetic field can be applied. The magnetic field attracts the magnetic biological particles, which can then be separated from the liquid by, for example, pouring off the liquid, removing aliquots of the liquid, or removing the attracted magnetic particles from the liquid.

The terms “sorb” and “sorbing” are general terms meaning to take up and hold by either adsorption or absorption, or both.

A magnetic field can be generated in ways well know in the art, such as by a permanent magnet, electromagnet, or alternating currents.

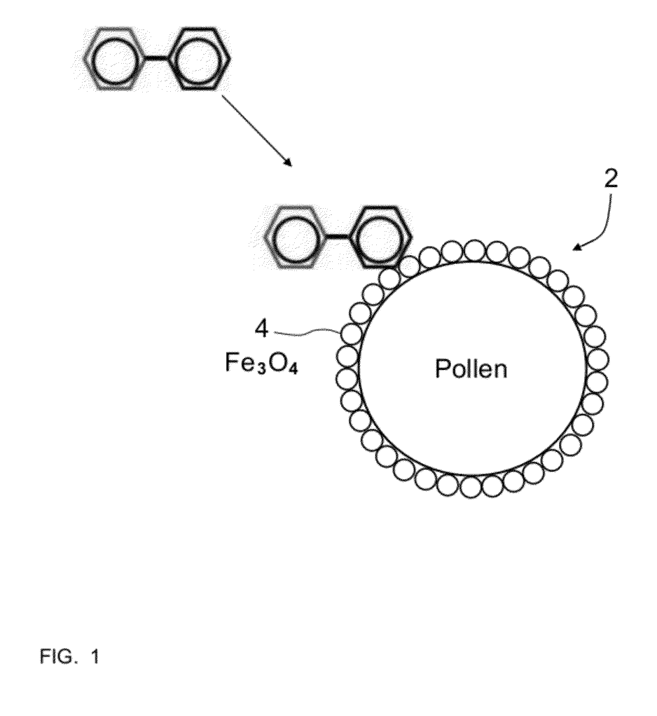

An embodiment of a method of removing biphenyl from a contaminated liquid is shown schematically in FIG. 1. In the figure, sorption of biphenyl by a magnetic pollen grain 2 having iron deposits 4 is shown.

The present invention may be better understood by referring to the accompanying examples, which are intended for illustration purposes only and should not in any sense be construed as limiting the scope of the invention.

### Example 1

The sorption capacity of magnetized ragweed pollen grains for HOCs were investigated using an abundant natural product as a resource to remove anthropogenic contaminants from the environment. The removal of three PAHs (acenaphthene, naphthalene and phenanthrene) and three chlorinated pesticides (atrazine, diuron, and lindane) were investigated. Their physicochemical properties are given in Table 1.

TABLE 1
Properties of the six selected HOCs for Sorption Studies (24)

| | | | Structure, | Octanol- | |
|---|---|---|---|---|---|
| | | | Molecular | Water | Sorption |
| | | | Formula | Partition | Partition |
| Class | | Molecular | or | Coefficient, | Coefficient, |
| of | Compound | Weight | Chlorine | Log K_{ow} | Log K_{oc} |
| Compound | Name | (g/mol) | Content | at 25° C. | at 25° C. |
| PAHs | Acenaphthene | 154.207 | 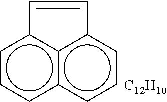 | 3.92 | 5.38 |
| | Naphthalene | 128.171 | 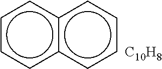 | 3.30 | 5.00 |
| | Phenanthrene | 178.229 | 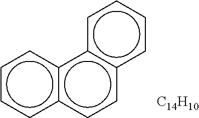 | 4.46 | 6.12 |
| Pesticides | Atrazine | 215.686 | 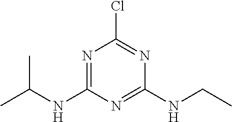 | 2.68 | 2.24 |
| | Diuron | 233.097 | 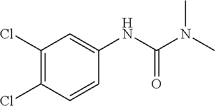 | 2.42 | 2.59 |
| | Lindane | 290.832 | 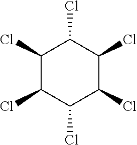 | 3.76 | 3.30 |

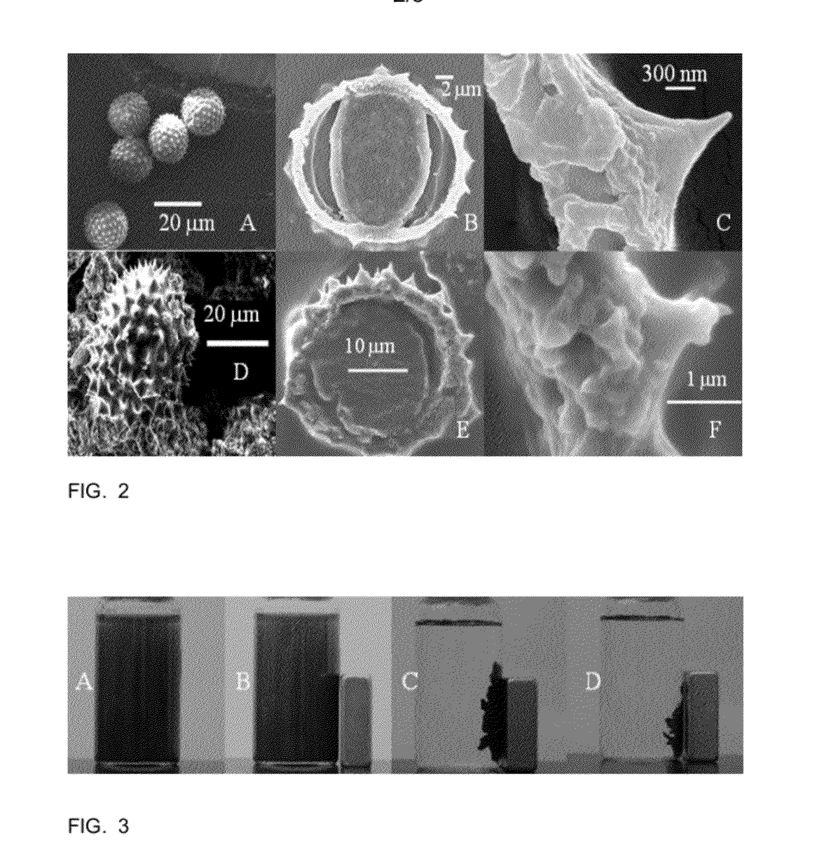

FIG. 2 shows the successful coating of magnetite onto the short ragweed pollen grains using scanning electron microscopy (SEM). In the figure, SEM images of untreated (A to C) and magnetized (D to F) ragweed pollen grains are shown. Close up views (E and F) of the sliced pollen grains show a deposit of magnetite on the outer and inner surfaces of the magnetized pollen exine. The presence of iron was confirmed by energy dispersive spectroscopy (EDS) and the elemental composition is listed in Table 2. Natural, uncoated ragweed pollen grains are composed mainly of carbon and oxygen with no iron. In FIG. 3, the results show that the magnetized ragweed pollen has a significant enough loading of magnetite coating that the suspension acts like a ferrofluid (20) in the presence of an external magnetic field: FIG. 3A, magnetized ragweed pollen are introduced to a vial containing acenapthene contaminated water; FIG. 3B, a permanent magnet is placed next to the vial and starts to attract the magnetic pollen grains; FIG. 3C, after 10 minutes, some of the pollen grains are on the right side of the vial; FIG. 3D, magnetized ragweed pollen remains attracted to the magnet 30 minutes after being first placed under an external magnetic field.

TABLE 2
Comparison of the elemental composition of unmodified ragweed pollen
grains with magnetized ragweed pollen by EDS.

| Ragweed pollen | | | Magnetized ragweed pollen | | |
|---|---|---|---|---|---|
| Element | Weight % | Atomic % | Element | Weight % | Atomic % |
| C | 57.91 | 64.75 | C | 68.86 | 77.03 |
| O | 41.80 | 35.09 | O | 25.18 | 21.14 |
| Na | 0.22 | 0.13 | Na | 0.17 | 0.07 |
| Si | 0.07 | 0.03 | Si | 0.30 | 0.13 |
| Cl | 0.00 | 0.00 | Cl | 2.24 | 0.85 |
| Fe | 0.00 | 0.00 | Fe | 3.25 | 0.78 |
| Totals | 100.00 | | Totals | 100.00 | |

The sorption of the HOCs onto magnetized ragweed pollen was evaluated by the batch equilibration method. The best fit of the data suggests a Freundlich isotherm (21-22):

q=K_{f}Cₑⁿ (1)

where q is the amount of contaminant adsorbed at equilibrium (mg/g), Cₑ is the equilibrium concentration of contaminant in solution (mg/L), K_{f} the Freundlich adsorption constant (mg/g) (L/mg)⁻ⁿ, and n the measure of adsorption intensity (dimensionless). Equation 1 can be linearized by taking the logarithmic form:

log q=log K_{f}+n log Cₑ (2)

and compared to the experimental data for HOCs. The Freundlich parameters K_{f} and n were determined by the intercept and slope of Equation 2. This behavior suggests a limited number of sorption sites on the magnetized pollen, which reaches a saturation limit.

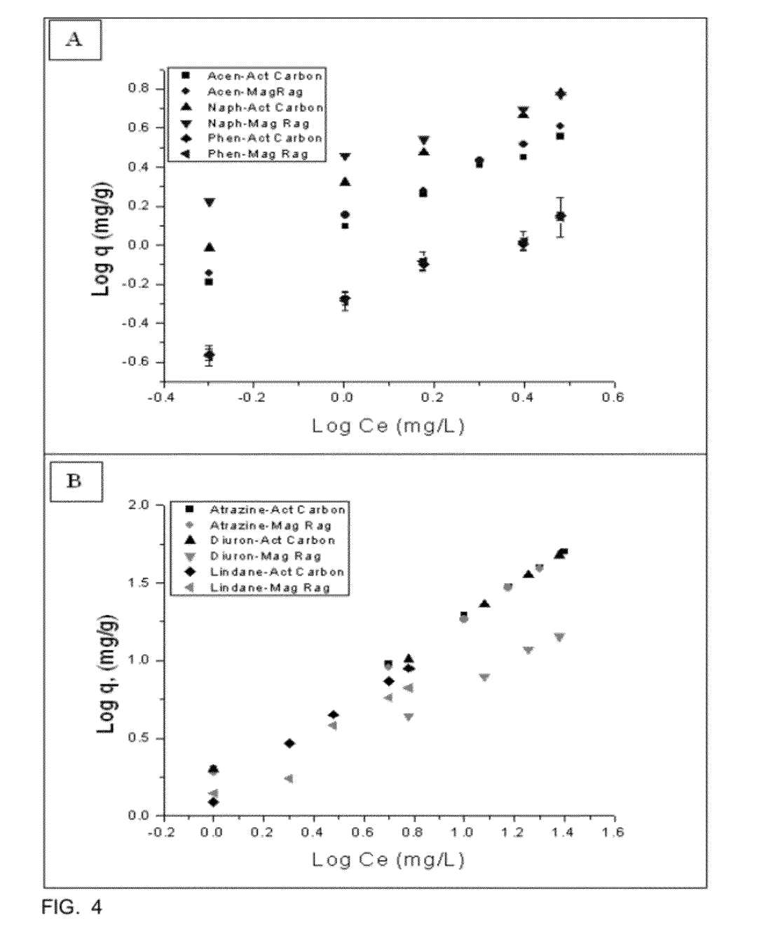

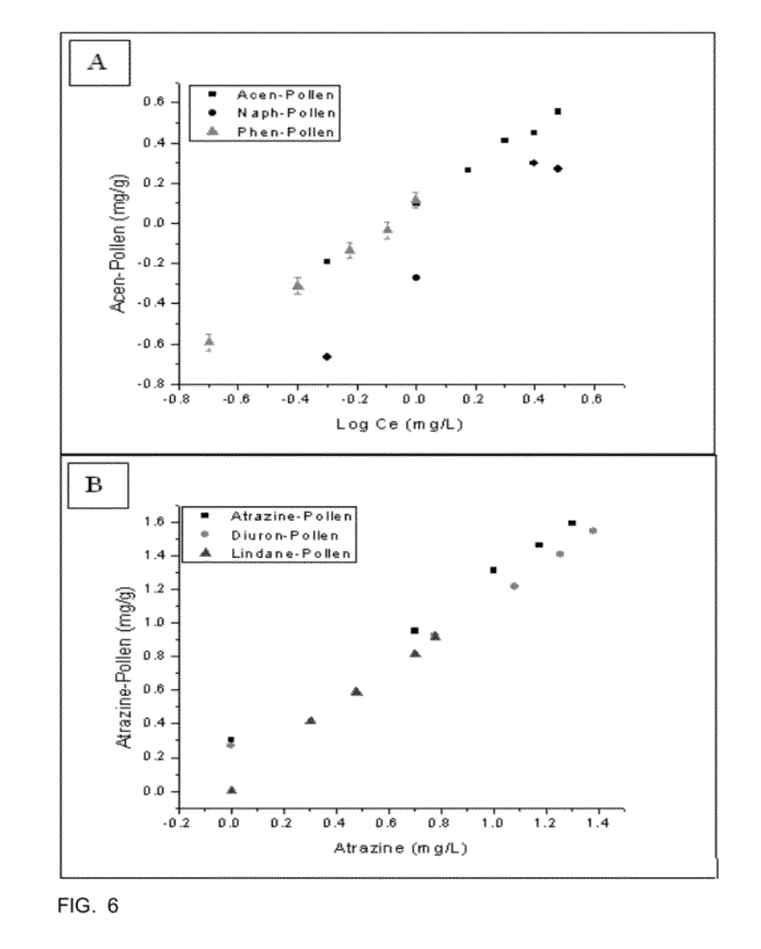

FIG. 4 presents the sorption performance of magnetized ragweed pollen compared to that of activated carbon for the HOCs, while Table 3 lists the Freundlich parameters calculated from the slope and linear regressions of FIG. 4 as well as the average efficiency of contaminant removal from both types of sorbent together with untreated ragweed pollen. It can be seen that magnetized ragweed pollen behaves similarly to activated carbon with regards to the sorption of HOCs. Both non-chlorinated and chlorinated HOCs sorbed to magnetized and untreated ragweed pollen as well as activated carbon, demonstrating ragweed pollen's potential to act as a non-specific organic contaminant sorbent from water. No significant difference in sorptivity between magnetized and untreated ragweed pollen was observed (see FIG. 6). While both types of ragweed pollen are excellent candidates to serve as sorbents for organic contaminants, the magnetized form allows easier separation of the pollen grains from the treated water.

TABLE 3
Measured HOC Sorption parameters from magnetized
ragweed pollen (MR) and Activated Carbon (AC).

| | K_{f}(mg/g)(L/mg)⁻ⁿ | | n | | Average % removal | | |
|---|---|---|---|---|---|---|---|
| HOC | MR | AC | MR | AC | UR | MR | AC |
| Acenaphthene | 1.427 | 0.644 | 0.997 | 0.998 | 61.2 | 68.5 | 61.2 |
| Naphthalene | 1.577 | 2.096 | 0.996 | 0.997 | 26 | 91.8 | 100 |
| Phenanthrene | 1.304 | 1.471 | 0.995 | 0.996 | 64.5 | 67.4 | 70.2 |
| Atrazine | 1.903 | 2.0 | 1.011 | 0.998 | 94.6 | 93.9 | 98.9 |
| Diuron | 0.839 | 2.0 | 0.997 | 1.001 | 70.7 | 56.4 | 98.3 |
| Lindane | 1.398 | 1.227 | 0.996 | 1.011 | 62.8 | 76.5 | 71.6 |

Untreated ragweed pollen (UR) is included in the average percent removal column for comparison with MR and AC.
Average % removal refers to average percent HOC removal across all initial HOC concentrations (0.5-20 ppm) tested with MR and AC. Standard deviations for RP, MR and AC average % removal vary from 0% to 9%.

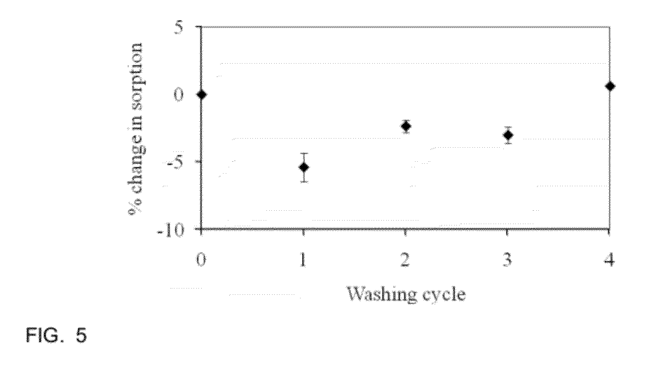

The ability to regenerate and reuse magnetized ragweed pollen, using common organic solvents to extract the HOCs, is of value even though the natural raw material is very inexpensive, since it reduces even more the overall cost. In addition, the recovered HOCs may be either reused or disposed of safely in a more concentrated solution. The reduction of the hazardous waste stream is significant due to the reusability of the magnetized ragweed pollen, on the order of several reuse cycles. Although activated carbon can be regenerated, it typically requires high temperatures and more sophisticated reactors, so most users simply dispose of it in a hazardous waste landfill after a single use. The recovery of acenaphthene was investigated using 3 mL of acetone, with a recovery rate of 81%, considering an initial acenaphthene concentration of 1 mg/L and 5 mg/L of magnetized ragweed pollen. The recovery of diuron sorbed onto magnetized ragweed pollen using methanol extraction was also evaluated. The percentage removal and recovery of diuron in five cycles of regeneration and reuse are shown in FIG. 5. No significant loss of HOC sorption capacity was observed for the magnetized ragweed pollen after repeated use.

As shown herein, functionalized pollen grains can be effective sorbents for HOCs to treat contaminated water, with similar levels of organic contaminant removal as traditional activated carbon. The magnetization of the pollen simplifies its separation from the treated water. Regeneration and reuse make this an ideal sorbent to treat contaminated water supplies. The use of a natural product for water treatment, which exhibits strong adsorption affinities to a wide range of hydrophobic organic contaminants, can have worldwide applicability.

### Example 2

### Synthesis and Characterization of Magnetic Ragweed Pollen Grains

The synthesis of magnetized ragweed pollen was done in four steps. First, 13.32 g FeCl3.6H2O (Fisher), 19.88 g FeCl2.4H2O (Fisher), 5 mL 5 M HCl (Fisher), 40 mL Nanopure deionized water and 5 mL ethanol (Sigma-Aldrich) were mixed in a 100 mL flask followed by heating to 40° C. until the Fe salts were completely dissolved. Second, 0.5 g of the short ragweed (A. artemisiifolia) pollen grains (Greer Labs, Lenoir, N.C.) were dispersed in 15 mL of the iron chlorides solution and stirred for 2 hours at room temperature. Third, the pollen suspension was filtered and quickly washed with Nanopure water and then immediately transferred into 1 M ammonia solution. Finally after 1 hour the magnetized pollen grains were filtered again and washed thoroughly with Nanopure water. The magnetized ragweed pollen were left in a scintillation vial and put into a convection oven at 60° C. to dry overnight before use.

The magnetized ragweed pollen and unmodified pollen grains were viewed under the SEM (XL40 Sirion FEG Digital Scanning Microscope w/EDS, FEI company, Hillsboro, Oreg.) as shown in FIG. 2. A Leica 1510S cryostat (Leica Microsystems Inc., Bannockburn, Ill.) was used to cut open both types of pollen grains in order to observe the inner composition of the pollen grains. The SEM images showed the magnetite coatings were on both the inside and outside surfaces of the exine. To evaluate the magnetization of the magnetized ragweed pollen, their response was tested by placing them in an external magnetic field. Further confirmation of the presence of Fe on the exine was verified by EDS. FIG. 3C-D show that the dispersion of magnetized ragweed pollen behaves like a ferrofluid.

### Sorption Isotherms of HOCs onto Magnetized Ragweed Pollen from Contaminated Water

Batch sorption experiments were performed by dosing each 15 mL test tube with 5 mg of magnetized ragweed pollen and 10 mL of contaminant. All batches were run at room temperature on a roller table at 60 RPM to mix vials end over end to disperse the sorbent throughout the aqueous phase. Mixing was done for 24 hours to achieve equilibrium. Magnetized ragweed pollen was magnetically separated from the aqueous phase and the aqueous phase was analyzed by gas chromatograph mass spectrometry (GC-MS), high performance liquid chromatography (HPLC), or UV-Vis spectrometry to determine the concentration of organic contaminant left behind in the aqueous phase. Acenaphthene, naphthalene, and lindane concentrations in the aqueous phase were analyzed using solid phase microextraction (SPME) and GC-MS. A 7 μm diameter PDMS fiber was used to extract the organic from the aqueous phase for twenty minutes and the fiber was injected into an injector and desorbed for five minutes. The GC was initially set to 50° C. and held for five minutes. The column was then ramped to 320° C. at a rate of 12° C./min and held for an additional ten minutes. Atrazine and diuron concentrations were analyzed with HPLC, while UV-Vis spectrometry was used for measuring the concentration of phenanthrene in the water. All experiments were performed by mixing the standards in each batch and a calibration curve was performed daily with a regression (R² value) of 0.98 or greater. Concentration of the organic compound sorbed to the magnetized ragweed pollen or activated carbon was calculated as the difference between the concentration dosed versus the equilibrated concentration left in the aqueous phase. Sorption isotherms and linear fits were analyzed using Origin Labs 8.1 software.

### Recovery of Organic Contaminants from Magnetized Ragweed Pollen

Acetone was used to extract a representative organic contaminant, acenaphthene, by sonicating the magnetized ragweed pollen with 3 mL of acetone in a Branson Ultrasonic Bath at 25° C. for 30 minutes. Extracts were analyzed via direct injection using a Varian 2100T GC-MS. The column was held at 50° C. for 5 min and ramped to 320° C. at 12° C./min and held for an additional 10 minutes. An average of 81% acenaphthene was recovered from the sorbed state on magnetized ragweed pollen at 1 mg/L acenapthene. This method was confirmed to be valid for PAHs (23).

### Regeneration and Reuse of Magnetized Ragweed Pollen

Magnetized ragweed pollen grains were mixed for four cycles of 24 hours after being dosed with diuron. The aqueous phase was decanted each time and analyzed on HPLC for percent removed after each round of reuse. Between cycles the particles were not rinsed with solvent. Fresh diuron was added at the same concentration as the original solution to each round of sorption to see how many times the sorbent could be reused without purification or regeneration in solvent.

### BET Surface Area Analysis

The starting material and the product were analyzed with BET nitrogen adsorption to determine the surface area of the materials. The iron coated pollen had a surface area of 0.678 m²/g and uncoated pollen had a surface area of 0.623 m²/g.

### REFERENCES

The following publications are incorporated by reference herein:
1. F. W. Heyl, J. Am. Chem. Soc 39, 1470 (1917).
2. J. H. Koessler, The Journal of Biological Chemistry 35, 415 (1917).
3. F. W. Heyl, J. Am. Chem. Soc 41, 1285 (1919).
4. F. W. Heyl, Hopkins, H. H., J. Am. Chem. Soc 42, 1738 (1920).
5. J. B. Paton, American Journal of Botany 8, 471 (1921).
6. R. B. Knox, Heslop-Harrison, J., J. Cell Sci 6, 1 (1970).
7. B. J. Howlett, Knox, R. B., Heslop-Harrison, J., J. Cell Sci 13, 603 (1973).
8. R. B. Knox, J. Cell Sci 12, 421 (1973).
9. V. N. Paunov, Mackenzie, G., Stoyanov, S. D., J. Mater. Chem. 17, 609 (2007).
10. B. J. Thio, Lee, J. H. Meredith, C. J., Environ. Sci. Technol. 43, 4308 (2009).
11. F. Schulte, Lingott, J., Panne, U., Kneipp, J., Anal. Chem. 80, 9551 (2008).
12. E. Pehlivan, Ersoz, M., Pehlivan, M., Yildiz, S., Duncan, H. J., J. Colloid and Interface Sci. 170, 320 (1995).
13. M. Samter, Talmage, D. W., Immunological diseases. (Little Brown, Boston, ed. 3, 1978).
14. C. Moreno-Castilla, Rivera-Utrilla, J., Joly, J. P., Lopez-Ramon, M. V., Ferro-Garcia, M. A., Carrasco-Marin, F., Carbon 33, 1417 (1995).
15. C. W. Huck, Bonn, G. K., J. Chromatogr. A. 885, 51 (2000).
16. W. D. Henry, Zhao, D., SenGupta, A. K. Lange, C., Reactive & Functional Polymers 60, 109 (2004).
17. F. Augusto, Carasek, E., Gomes Costa Silva, R., Rivellion, S. R., Domingues Batista, A., Martendal, E, J. Chromatogr. A. 1217, 2533 (2010).
18. C. Valderrama, Cortina, J. L., Farran, A., Gamisans, X., de las Heras, F. X., Reactive & Functional Polymers 68, 718 (2008).
19. P. Wang, Shi, Q., Shi, Y., Clark, K. K., Stucky, G. D., Keller, A. A., J. Am. Chem. Soc 131, 182 (2009).
20. P. Berger, Adelman, N. B., Beckman, K. J., Campbell, D. J., Ellis, A. B., Lisensky, G. C., J. Chem. Educ. 76, 943 (1999).
21. R. P. Schwarzenbach, Gschwend, P. M., Imboden, D. M., Environmental Organic Chemistry. (Wiley, New York, 2003).
22. L. K. Wang, Hung, Y-T., Shammas, N. K., Advanced physicochemical treatment technologies. Handbook of Environmental Engineering (Humana Press, Totowa, 2007), vol. 5.
23. L. Sarrazin, Diana, C., Wafo, E., Pichard-Lagadec, V., Schembri, T., Monod, J-L., Journal of Liquid Chromatography & Related Technologies 29, 69 (2006).
24. D. Mackay, Shiu, W. Y., Ma, K-C., Lee, S. C., Handbook of Physical-Chemical Properties and Environmental Fate for Organic Chemicals. (CRC Press, Taylor & Francis Group, Boca Raton, 2006), vol. 4.

Although the present invention has been described in connection with the preferred embodiments, it is to be understood that modifications and variations may be utilized without departing from the principles and scope of the invention, as those skilled in the art will readily understand. Accordingly, such modifications may be practiced within the scope of the invention and the following claims.

What is claimed is:

1. A method of removing a contaminant from liquid, comprising:
adding magnetic biological particles to a liquid containing a contaminant;
sorbing the contaminant to the magnetic biological particles; and
separating the sorbed contaminant from the liquid by applying a magnetic field to the magnetic biological particles.

2. The method of claim 1, wherein the liquid is water or an aqueous liquid.

3. The method of claim 1, wherein the contaminant is a volatile organic compound, a semi-volatile organic compound, a phenolic compound, a polycyclic aromatic hydrocarbon, a polychlorinated biphenyl, or an organic pesticide, insecticide or herbicide, or any combination thereof.

4. The method of claim 3, wherein the contaminant is a hydrophobic organic compound (HOC).

5. The method of claim 1, wherein the magnetic biological particles comprise pollen grains, chitin molecules, chitosans, plant cuticles, biofilms, fungal spores, or a combination thereof.

6. The method of claim 5, wherein the magnetic biological particles comprise pollen grains.

7. The method of claim 1, wherein each of the magnetic biological particles comprises a ferromagnetic or superparamagnetic material, or a combination thereof.

8. The method of claim 1, wherein the magnetic biological particles comprise biological particles with added magnetic material.

9. The method of claim 1, further comprising collecting the magnetic biological particles after applying the magnetic field, and reusing the collected magnetic biological particles for contaminant removal.

10. A method of preparing a magnetic biological particle, comprising adding a magnetic material to a biological particle in an amount to produce a composite particle that is attracted by a magnetic field.

11. The method of claim 10, wherein the biological particle is capable of sorbing a contaminant.

12. The method of claim 11 wherein the contaminant is a hydrophobic organic compound (HOC).

13. The method of claim 10, wherein the biological particle is a pollen grain, chitin, chitosan, a plant cuticle, a biofilm, or a fungal spore.

14. The method of claim 13, wherein the biological particle is a pollen grain.

15. The method of claim 10, wherein the magnetic material is a ferromagnetic or superparamagnetic material, or a combination thereof.

16. A magnetic composition comprising biological particles having added magnetic material in an amount such that the biological particles are attracted by a magnetic field.

17. The composition of claim 16, wherein the biological particles are capable of sorbing a contaminant.

18. The composition of claim 17, wherein the contaminant is a hydrophobic organic compound (HOC).

19. The composition of claim 16, wherein the biological particles comprise pollen grains, chitin molecules, chitosans, plant cuticles, biofilms, or fungal spores, or a combination thereof.

20. The composition of claim 19, wherein the biological particles comprise pollen grains.

21. The composition of claim 16, wherein the magnetic material is a ferromagnetic or superparamagnetic material, or a combination thereof.
